(19) United States
(12) Patent Application Publication
(10) Pub. No.: US 2020/0193011 A1
(43) Pub. Date: Jun. 18, 2020

(54) 2-WAY DUAL AUTHENTICATION OF SELF ENCRYPTED STORAGE DRIVES

(71) Applicant: SEAGATE TECHNOLOGY LLC, Cupertino, CA (US)

(72) Inventor: Jean-Pierre Ruster, San Jose, CA (US)

(73) Assignee: SEAGATE TECHNOLOGY LLC, Cupertino, CA (US)

(21) Appl. No.: 16/224,572

(22) Filed: Dec. 18, 2018

(51) Int. Cl. G06F 21/44; G06F 21/32; G06F 21/73

(52) U.S. Cl. CPC G06F 21/445; G06F 21/78; G06F 21/73; G06F 21/32

(57) ABSTRACT

Systems and methods for 2-way dual authentication are described. In one embodiment, the method may include detecting, by a controller of a storage drive, a connector of the storage drive connected to a connector of a computing device; sending, by the controller, information to the computing device based at least in part on the detecting; receiving, by the controller, an acknowledgment from the computing device indicating the information is successfully authenticated; performing, by the controller, a credential verification process based at least in part on receiving the acknowledgment; and allowing, by the controller, the computing device to mount a storage medium of the storage drive on an operating system of the computing device after successful verification of credentials in the credential verification process.

### SUMMARY

The present disclosure is directed to methods and systems for 2-way dual authentication. In some embodiments, the present systems and methods may perform a 2-way authentication of self-encrypting storage drives.

A storage drive for 2-way dual authentication is described. In one embodiment, the storage drive may include a hardware controller. In some embodiments, the hardware controller may be configured to detect a connector of the storage drive connected to a connector of a computing device, send information to the computing device based at least in part on the detecting, receive an acknowledgment from the computing device indicating the information is successfully authenticated, perform a credential verification process based at least in part on the acknowledgment, and allow the computing device to mount a storage medium of the storage drive on an operating system of the computing device after successful verification of credentials in the credential verification process.

In some cases, the hardware controller may be further configured to prevent the credential verification process based at least in part on failing to receive the acknowledgment within a set time period or after receiving a negative acknowledgment from the computing device, wherein the computing device is prevented from mounting the storage medium without the successful verification of the credentials in the credential verification process.

In some cases, performing the credential verification process includes the hardware controller being further configured to request the credentials from the computing device, wherein the credentials include at least one of a user name and password, a fingerprint scan, an eye scan, a face scan, a voice capture, or any combination thereof. In some cases, performing the credential verification process further includes the hardware controller being configured to receive the requested credentials from the computing device and verify the received credentials.

In some cases, sending the information to the computing device includes the hardware controller being configured to send a provisioning file stored on the storage drive or data saved to the provisioning file. In some cases, the provisioning file may be stored on a memory (e.g., read only memory, flash memory, etc.) located on a bridge interface of the storage drive. In some cases, the bridge interface is connected between the hardware controller of the storage drive and the connector of the storage drive.

In some examples, the data stored in the provisioning file and/or the information sent to the computing device may include at least one of a device serial number of the storage drive, a globally unique identifier uniquely associated with the storage drive, a serial number of the computing device, a globally unique identifier uniquely associated with the computing device, a host machine name associated with computing device, a media access control (MAC) number of the computing device, a processor identifier of a processor of computing device, a motherboard serial number of the computing device, or a unique random generated number generated by the storage drive based at least in part on the detecting, or any combination thereof. In some cases, the connector of the storage drive includes a universal serial bus (USB) connector or a similar connector used to connect a storage drive to a device external to the storage device. In some cases, the storage drive includes a self-encrypting drive.

A computing device for 2-way dual authentication is also described. In one embodiment, the computing device may include one or more processors, memory in electronic communication with the one or more processors, and instructions stored in the memory, the instructions being executable by the one or more processors to perform the steps of monitoring a connector of the computing device; detecting a storage drive connected to the connector based at least in part on the monitoring; receiving information from the storage drive based at least in part on the detecting; authenticating the information from the storage drive; performing a credential verification process based at least in part on successfully authenticating the information; and mounting a storage medium of the storage drive on an operating system of the computing device based at least in part on a result of the credential verification process.

In some cases, the instructions for performing the credential verification process further cause the one or more processors to perform the steps of receiving credentials from a user; sending the credentials to the storage drive for verification; and receiving the result of the credential verification process from the storage drive, the result indicating that the credentials are valid or that the credentials are invalid, wherein the one or more processors mounting the storage medium when the result indicates the credentials are valid.

In some cases, receiving the information from the storage drive includes receiving a file stored on the storage drive or receiving data from the file. In some cases, the file includes at least one of a drive identifier unique to the storage drive and a computer identifier unique to the computing device.

In some cases, the instructions for authenticating the information when executed by the one or more processors cause the one or more processors to perform the steps of comparing the drive identifier to a local drive identifier stored on at least one of an internal storage drive of the computing device and a remote storage drive and indicating the information is authenticated when the comparing indicates a match between the drive identifier and the local drive identifier.

In some cases, the instructions for authenticating the information when executed by the one or more processors cause the one or more processors to perform the steps of comparing the computer identifier to a device identifier associated with the computing device and indicating the information is authenticated when the comparing indicates a match between the computer identifier and the device identifier.

In some cases, the instructions when executed by the one or more processors cause the one or more processors to perform the steps of receiving a command instructing the computing device to block further communication with the storage drive.

In some cases, the instructions when executed by the one or more processors cause the one or more processors to perform the steps of determining whether the storage drive is currently connected to the computing device and unmounting the storage drive after determining the storage drive is currently connected.

In some cases, the instructions when executed by the one or more processors cause the one or more processors to perform the steps of removing authentication of the information to block future connections between the computing device and the storage drive after determining the storage drive is not currently connected.

A method for 2-way dual authentication is also described. In one embodiment, the method may include detecting, by a controller of a storage drive, a connector of the storage drive connected to a connector of a computing device; sending, by the controller, information to the computing device based at least in part on the detecting; receiving, by the controller, an acknowledgment from the computing device indicating the information is successfully authenticated; performing, by the controller, a credential verification process based at least in part on receiving the acknowledgment; and allowing, by the controller, the computing device to mount a storage medium of the storage drive on an operating system of the computing device after successful verification of credentials in the credential verification process.

The foregoing has outlined rather broadly the features and technical advantages of examples according to this disclosure so that the following detailed description may be better understood. Additional features and advantages will be described below. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, including their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following a first reference label with a dash and a second label that may distinguish among the similar components. However, features discussed for various components, including those having a dash and a second reference label, apply to other similar components. If only the first reference label is used in the specification, the description is applicable to any one of the similar components having the same first reference label irrespective of the second reference label.

FIG. 1 is a block diagram of an example of a system in accordance with various embodiments;

FIG. 2 shows a block diagram of a device in accordance with various aspects of this disclosure;

FIG. 3 shows a block diagram of one or more modules in accordance with various aspects of this disclosure;

FIG. 4 shows a diagram of a system in accordance with various aspects of this disclosure;

FIG. 5 shows one embodiment of an environment in accordance with various aspects of this disclosure;

FIG. 6 shows one embodiment of an environment in accordance with various aspects of this disclosure;

FIG. 7 shows a diagram of a system in accordance with various aspects of this disclosure;

FIG. 8 is a flow chart illustrating an example of a method in accordance with various aspects of this disclosure; and

FIG. 9 is a flow chart illustrating an example of a method in accordance with various aspects of this disclosure.

### DETAILED DESCRIPTION

The following relates generally to 2-way dual authentication. In one embodiment, the present techniques may include 2-way authentication of self-encrypting storage drives. Currently, the encrypted data stored on a conventional 1-way authentication self-encrypting drive may be accessed via successful verification of user credentials. Also, encrypted data stored on a conventional 2-factor authentication self-encrypting drive may be accessed via (a) a first factor such as successful verification of user credentials; and (b) a second factor such as confirmation and/or a code provided on a third device such as a mobile device, etc. However, neither of the existing conventional authentication methods include authentication in association with a device the self-encrypting drive connects to such as a computing device (e.g., desktop computer, laptop computer, etc.). Accordingly, a conventional self-encrypting drive may be accessed on any computing device it connects to, resulting in the conventional self-encrypting drive being accessible to anyone that knows the credentials, or anyone that knows the credentials and has access to a second factor device such as a mobile computing device.

The present techniques provide additional security to self-encrypting drives by providing 2-way dual authentication. The present techniques include pairing a self-encrypting drive to at least one computing device and allowing the self-encrypting drive to be accessible only on a paired computing device. After confirming that the self-encrypting drive is connected to a paired computing device, then the self-encrypting drive and/or the paired computing device may request user credentials to unlock the self-encrypting drive. Thus, the 2-way dual authentication of the present techniques includes authentication from two ways: (a) a first authentication between a computing device and the self-encrypting drive to confirm that the computing device is a paired computing device; and (b) a second authentication between the self-encrypting drive and a user to confirm user credentials to unlock the self-encrypting drive. When the self-encrypting drive of the present techniques is connected to a non-paired computing device, then the first authentication fails and the second authentication is never reached. Accordingly, the present techniques improve the security of self-encrypting drives by providing 2-way dual authentication.

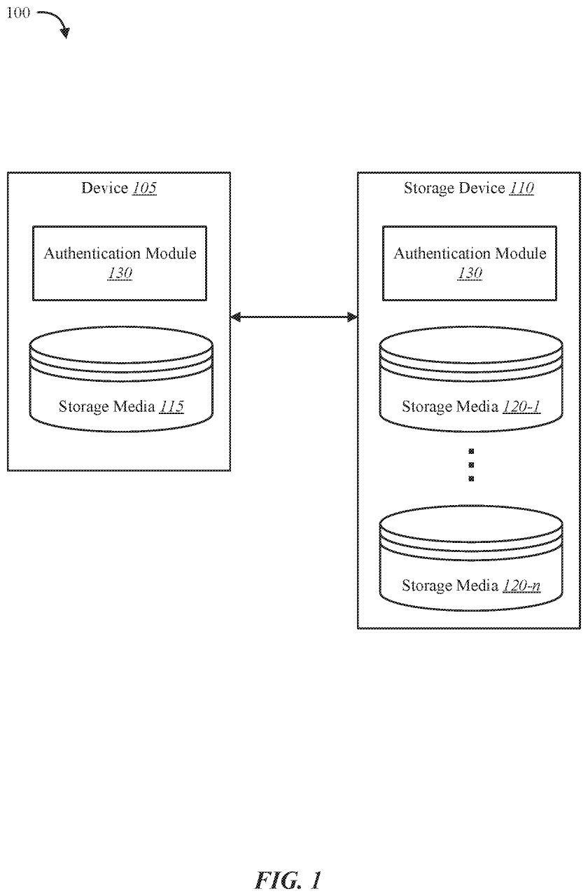

FIG. 1 is a block diagram illustrating one embodiment of an environment 100 in which the present systems and methods may be implemented. The environment may include device 105 and storage device 110.

Device 105 may include storage media 115. The storage media 115 may include any combination of hard disk drives, solid state drives, and hybrid drives that include both hard disk and solid state drives. In some embodiments, the systems and methods described herein may be performed on a single device such as device 105. In some cases, the methods described herein may be performed on multiple storage devices or a network of storage devices such a cloud storage system and/or a distributed storage system. Examples of device 105 include a computing device (e.g., desktop computer, laptop computer, etc.), a network device (e.g., wired router, wired switch, network hub, network gateway, wireless router, etc.), a server, or any combination thereof. In some configurations, device 105 may include authentication module 130. In some embodiments, device 105 and storage media 115 may be components of flash memory or a solid state drive and/or another type of storage drive. Alternatively, device 105 may be a component of a host of the storage media 115 such as an operating system, host hardware system, or any combination thereof.

In one embodiment, device 105 may be a computing device with one or more processors, memory, and/or one or more storage devices. In some cases, device 105 may include a wireless storage device. In some embodiments, device 105 may include a cloud drive for a home or office setting. In one embodiment, device 105 may include a network device such as a switch, router, access point, or any combination thereof. In one example, device 105 may be operable to receive data streams, store and/or process data, and/or transmit data from, to, or in conjunction with one or more local and/or remote computing devices.

Storage device 110 may include one or more storage media 120 (e.g., storage media 120-1 to storage media 120-n where n is a positive integer of 2 or greater). In some cases, storage device 110 may include one or more self-encrypting storage drives. For example, storage device 110 may include a storage server with one or more self-encrypting storage drives, a storage enclosure with one or more self-encrypting storage drives, a storage controller of one or more self-encrypting storage drives, self-encrypting storage drives in a distributed storage system, self-encrypting storage drives on a cloud storage system, personal computing devices with one or more self-encrypting storage drives, or any combination thereof. In some embodiment, the storage media 115 and/or 120 may include heat assisted magnetic recording (HAMR), or shingled magnetic recording (SMR) storage drives.

The device 105 and/or storage device 110 may include a database. In some cases, the database may be internal to device 105 and/or storage device 110. In some embodiments, storage media 115 and/or 120 may include a database. Additionally, or alternatively, device 105 and/or storage device 110 may include a wired and/or a wireless connection to an external database. Additionally, as described in further detail herein, software and/or firmware (for example, stored in memory) may be executed on a processor of device 105 and/or storage device 110. Such software and/or firmware executed on the processor may be operable to cause the device 105 and/or storage device 110 to monitor, process, summarize, present, and/or send a signal associated with the operations described herein.

In some embodiments, storage media 115 and/or 120 may connect to device 105 and/or storage device 110 via one or more networks. Examples of networks include cloud networks, local area networks (LAN), wide area networks (WAN), virtual private networks (VPN), a personal area network, near-field communication (NFC), a telecommunications network, wireless networks (using 802.11, for example), and cellular networks (using 3G and/or LTE, for example), or any combination thereof. In some configurations, the network may include the Internet and/or an intranet. The device 105 and/or storage device 110 may receive and/or send signals over a network via a wireless communication link. In some embodiments, a user may access the functions of device 105 and/or storage device 110 via a local computing device, remote computing device, and/or network device. For example, in some embodiments, device 105 and/or storage device 110 may include an application that interfaces with a user. In some cases, device 105 and/or storage device 110 may include an application that interfaces with one or more functions of a network device, remote computing device, and/or local computing device.

In some cases, authentication module 130 may enable 2-way authentication of storage device 110. In some cases, authentication module 130 may detect a connector of storage device 110 connected to and/or being connected to a connector of device 105. In some cases, authentication module 130 may send information to device 105 based at least in part on the detecting, receive an acknowledgment from device 105 indicating the information is successfully authenticated, and perform a credential verification process based at least in part on the acknowledgment. In some cases, authentication module 130 may allow device 105 to mount at least a portion of storage media 120 of the storage device 110 on an operating system of device 105 after successful verification of credentials in the credential verification process.

In one embodiment, authentication module 130 may monitor a connector of the device 105, detect storage device 110 connected to and/or being connected to the monitored connector based at least in part on the monitoring, and receive information from storage device 110 based at least in part on the detecting. In some cases, authentication module 130 may include authenticating the information from the storage device 110, performing a credential verification process based at least in part on successfully authenticating the information, and mounting at least a portion of the storage media 120 of storage device 110 on an operating system of device 105 based at least in part on a result of the credential verification process. Accordingly, authentication module 130 improves the security of self-encrypting drives by providing 2-way dual authentication.

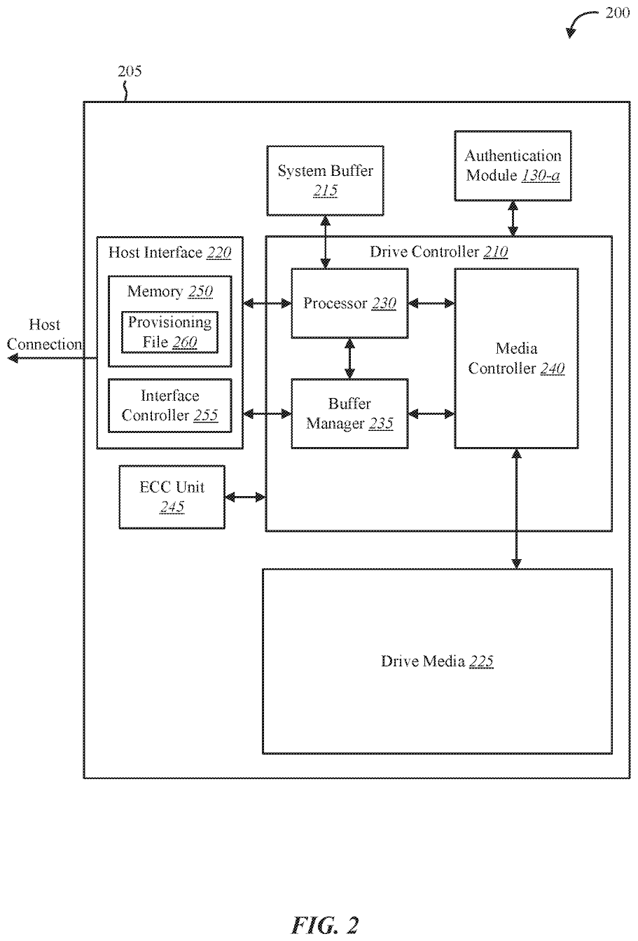

FIG. 2 shows a block diagram 200 of an apparatus 205 for use in electronic communication, in accordance with various aspects of this disclosure. The apparatus 205 may be an example of one or more aspects of device 105 described with reference to FIG. 1. The apparatus 205 may include a drive controller 210, system buffer 215, host interface 220, drive media 225, and authentication module 130-a. Each of these components may be in communication with each other and/or other components directly and/or indirectly.

One or more of the components of the apparatus 205, individually or collectively, may be implemented using one or more application-specific integrated circuits (ASICs) adapted to perform some or all of the applicable functions in hardware. Alternatively, the functions may be performed by one or more other processing units (or cores), on one or more integrated circuits. In other examples, other types of integrated circuits may be used such as Structured/Platform ASICs, Field Programmable Gate Arrays (FPGAs), and other Semi-Custom ICs, which may be programmed in any manner known in the art. The functions of each module may also be implemented, in whole or in part, with instructions embodied in memory formatted to be executed by one or more general and/or application-specific processors.

In one embodiment, the drive controller 210 may include a processor 230, a buffer manager 235, and a media controller 240. The drive controller 210 may process, via processor 230, read and write requests in conjunction with the host interface 220, the interface between the apparatus 205 and the host of apparatus 205. In some cases, host interface 220 may include an interface between an external connector of apparatus 205 and the drive controller 210 (e.g., a bridge interface between drive controller 210 and a universal serial bus (USB) connector of apparatus 205, etc.). In some cases, interface controller 255 may include a bridge controller. In some cases, interface controller 255 may control the interface between the external connector of apparatus 205 and the drive controller 210. As shown, host interface 220 may include memory 250 and interface controller 255. In some cases, memory 250 may include a read-only memory and/or flash memory. In some examples, memory 250 may store a provisioning file 260. In some cases, provisioning file 260 may store information associated with apparatus 205 and/or a host of apparatus 205. In some cases, interface controller 255 may be configured to identify when apparatus 205 connects to an external device (e.g., a host of apparatus 205), to identify when a message or signal is received from an external device (e.g., host of apparatus 205, etc.), to retrieve information from memory 250 (e.g., retrieve information from provisioning file 260), and/or to send the retrieved information to an external device (e.g., sending information to a host of apparatus 205, etc.).

The system buffer 215 may hold data temporarily for internal operations of apparatus 205. For example, a host may send data to apparatus 205 with a request to store the data on the drive media 225. Drive media 225 may include one or more disk platters, flash memory, any other form of non-volatile memory, or any combination thereof. The drive controller 210 may process the request and store the received data in the drive media 225. In some cases, a portion of data stored in the drive media 225 may be copied to the system buffer 215 and the processor 230 may process or modify this copy of data and/or perform an operation in relation to this copy of data held temporarily in the system buffer 215. In some cases, error correction control (ECC) unit 245 may perform error correction on data stored in drive media 225.

In some embodiments, authentication module 130-a may include at least one of one or more processors, one or more memory devices, one or more storage devices, instructions executable by one or more processors stored in one or more memory devices and/or storage devices, or any combination thereof. Although depicted outside of drive controller 210, in some embodiments, authentication module 130-a may include software, firmware, and/or hardware located within drive controller 210 and/or operated in conjunction with drive controller 210. For example, authentication module 130-a may include at least a portion of processor 230, buffer manager 235, and/or media controller 240. In one example, authentication module 130-a may include one or more instructions executed by processor 230, buffer manager 235, and/or media controller 240.

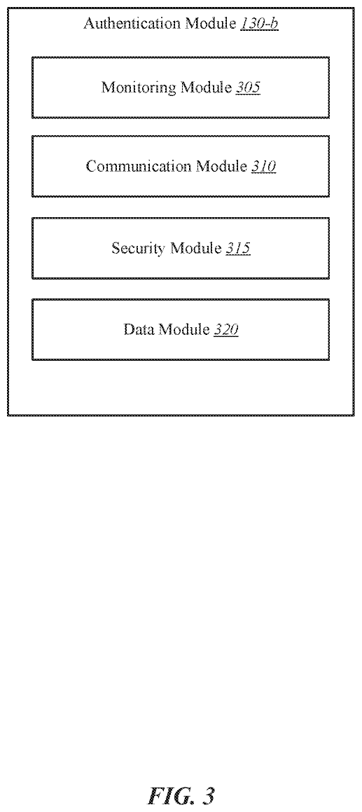

FIG. 3 shows a block diagram of authentication module 130-b. The authentication module 130-b may include one or more processors, memory, and/or one or more storage devices. The authentication module 130-b may include monitoring module 305, communication module 310, security module 315, and data module 320. The authentication module 130-b may be one example of authentication module 130 of FIGS. 1 and/or 2. Each of these components may be in communication with each other.

In some cases, monitoring module 305 may be configured to detect a connector of the storage drive connected to a connector of a computing device. In some cases, communication module 310 may be configured to send information to the computing device based at least in part on the detecting of the monitoring module 305. In some cases, communication module 310 may be configured to receive an acknowledgment from the computing device indicating the information is successfully authenticated,

In some cases, security module 315 may be configured to perform a credential verification process based at least in part on the acknowledgment. In some cases, security module 315 may be configured to allow the computing device to mount a storage medium of the storage drive on an operating system of the computing device after successful verification of credentials in the credential verification process.

In some cases, security module 315 may be configured to prevent the credential verification process based at least in part on failing to receive the acknowledgment within a set time period or after receiving a negative acknowledgment from the computing device. In some cases, the computing device may be prevented from mounting the storage medium without the successful verification of the credentials in the credential verification process.

In some cases, security module 315 may be configured to request the credentials from the computing device. In some cases, the credentials include at least one of a user name and password, a fingerprint scan, an eye scan, a face scan, a voice capture, or any combination thereof. In some cases, security module 315 may be configured to receive the requested credentials from the computing device and verify the received credentials.

In some cases, communication module 310 may be configured to send to the computing device a provisioning file stored on the storage drive or data that is saved to the provisioning file. In some cases, the provisioning file is stored on a memory located on a bridge controller of the storage drive. In some cases, the bridge interface is connected between the hardware controller of the storage drive and the connector of the storage drive.

In some cases, the information stored in the provisioning file includes at least one of a device serial number of the storage drive, a globally unique identifier uniquely associated with the storage drive, a serial number of the computing device, a globally unique identifier uniquely associated with the computing device, a host machine name associated with computing device, a media access control (MAC) number of the computing device, a processor identifier of a processor of computing device, a motherboard serial number of the computing device, or a unique random generated number generated by the storage drive based at least in part on the detecting, or any combination thereof. In some cases, the connector of the storage drive includes a universal serial bus (USB) connector. In some cases, the storage drive includes a self-encrypting drive.

In some cases, monitoring module 305 may be configured to monitor a connector of the computing device. In some cases, monitoring module 305 may be configured to detect a storage drive connected to the connector based at least in part on the monitoring. In some cases, communication module 310 may be configured to receive information from the storage drive based at least in part on the detecting. In some cases, security module 315 may be configured to authenticate the information from the storage drive. In some cases, security module 315 may be configured to perform a credential verification process based at least in part on successfully authenticating the information. In some cases, the security module 315 may block communication with the storage drive when the result indicates the credentials are invalid and/or when authentication fails. In some cases, data module 320 may be configured to mount a storage medium of the storage drive on an operating system of the computing device based at least in part on a result of the credential verification process.

In some cases, security module 315 may be configured to receive credentials from a user, send the credentials to the storage drive for verification, and receive the result of the credential verification process from the storage drive. In some cases, the result may indicate that the credentials are valid or that the credentials are invalid. In some cases, the data module 320 may mount the storage medium when the result indicates the credentials are valid.

In some cases, receiving the information from the storage drive includes receiving a file stored on the storage drive or receiving data from the file. In some cases, the file includes at least one of a drive identifier unique to the storage drive, a computer identifier unique to the computing device, or a random generated number, or any combination thereof.

In some cases, security module 315 may be configured to compare the drive identifier to a local drive identifier stored on at least one of an internal storage drive of the computing device and a remote storage drive, and indicate the information is authenticated when the comparing indicates a match between the drive identifier and the local drive identifier.

In some cases, security module 315 may be configured to compare the computer identifier to a device identifier associated with the computing device, and indicate the information is authenticated when the comparing indicates a match between the computer identifier and the device identifier.

In some cases, security module 315 may be configured to block further communication with the storage drive based on receiving a command instructing the computing device to block further communication with the storage drive. In some cases, after receiving a command instructing the computing device to block further communication with the storage drive, security module 315 may be configured to determine whether the storage drive is currently connected to the computing device, and unmounting the storage drive after determining the storage drive is currently connected.

In some cases, after receiving a command instructing the computing device to block further communication with the storage drive and determining the storage drive is not currently connected, security module 315 may be configured to remove authentication of the information to block future connections between the computing device and the storage drive.

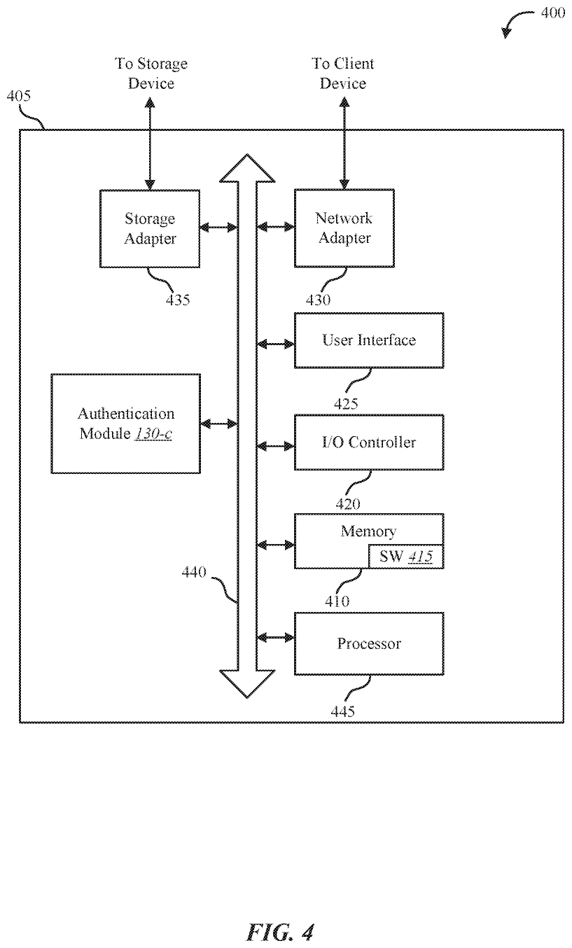

FIG. 4 shows a system 400 for 2-way dual authentication, in accordance with various examples. System 400 may include an apparatus 405, which may be an example of any one of device 105 of FIG. 1 and/or apparatus 205 of FIG. 2.

Apparatus 405 may include components for bi-directional voice and data communications including components for transmitting communications and components for receiving communications. For example, apparatus 405 may communicate bi-directionally with one or more storage devices and/or client systems. This bi-directional communication may be direct (apparatus 405 communicating directly with a storage system, for example) and/or indirect (apparatus 405 communicating indirectly with a client device through a server, for example).

Apparatus 405 may also include a processor module 445, and memory 410 (including software/firmware code (SW) 415), an input/output controller module 420, a user interface module 425, a network adapter 430, and a storage adapter 435. The software/firmware code 415 may be one example of a software application executing on apparatus 405. The network adapter 430 may communicate bi-directionally, via one or more wired links and/or wireless links, with one or more networks and/or client devices. In some embodiments, network adapter 430 may provide a direct connection to a client device via a direct network link to the Internet via a POP (point of presence). In some embodiments, network adapter 430 of apparatus 405 may provide a connection using wireless techniques, including digital cellular telephone connection, Cellular Digital Packet Data (CDPD) connection, digital satellite data connection, and/or another connection. The apparatus 405 may include authentication module 130-c, which may perform the functions described above for the authentication module 130 of FIGS. 1, 2, and/or 3.

The signals associated with system 400 may include wireless communication signals such as radio frequency, electromagnetics, local area network (LAN), wide area network (WAN), virtual private network (VPN), wireless network (using 802.11, for example), cellular network (using 3G and/or LTE, for example), and/or other signals. The network adapter 430 may enable one or more of WWAN (GSM, CDMA, and WCDMA), WLAN (including Wi-Fi and/or near field wireless), WMAN (WiMAX) for mobile communications, antennas for Wireless Personal Area Network (WPAN) applications (including RFID and UWB), or any combination thereof.

One or more buses 440 may allow data communication between one or more elements of apparatus 405 such as processor module 445, memory 410, I/O controller module 420, user interface module 425, network adapter 430, and storage adapter 435, or any combination thereof.

The memory 410 may include random access memory (RAM), read only memory (ROM), flash memory, and/or other types. The memory 410 may store computer-readable, computer-executable software/firmware code 415 including instructions that, when executed, cause the processor module 445 to perform various functions described in this disclosure. Alternatively, the software/firmware code 415 may not be directly executable by the processor module 445 but may cause a computer (when compiled and executed, for example) to perform functions described herein. Alternatively, the computer-readable, computer-executable software/firmware code 415 may not be directly executable by the processor module 445, but may be configured to cause a computer, when compiled and executed, to perform functions described herein. The processor module 445 may include an intelligent hardware device, for example, a central processing unit (CPU), a microcontroller, an application-specific integrated circuit (ASIC), field programmable gate array (FPGA), or any combination thereof.

In some embodiments, the memory 410 may contain, among other things, the Basic Input-Output system (BIOS) which may control basic hardware and/or software operation such as the interaction with peripheral components or devices. For example, at least a portion of the authentication module 130-c to implement the present systems and methods may be stored within the system memory 410. Applications resident with system 400 are generally stored on and accessed via a non-transitory computer readable medium, such as a hard disk drive or other storage medium. Additionally, applications can be in the form of electronic signals modulated in accordance with the application and data communication technology when accessed via a network interface such as network adapter 430.

Many other devices and/or subsystems may be connected to and/or included as one or more elements of system 400 (for example, a personal computing device, mobile computing device, smart phone, server, internet-connected device, cell radio module, or any combination thereof). In some embodiments, all of the elements shown in FIG. 4 need not be present to practice the present systems and methods. The devices and subsystems can be interconnected in different ways from that shown in FIG. 4. In some embodiments, an aspect of some operation of a system, such as that shown in FIG. 4, may be readily known in the art and are not discussed in detail in this application. Code to implement the present disclosure can be stored in a non-transitory computer-readable medium such as one or more of system memory 410 or other memory. The operating system provided on I/O controller module 420 may be a mobile device operation system, a desktop/laptop operating system, or another known operating system.

The I/O controller module 420 may operate in conjunction with network adapter 430 and/or storage adapter 435. The network adapter 430 may enable apparatus 405 with the ability to communicate with client devices such as device 105 of FIG. 1, and/or other devices over a communication network. Network adapter 430 may provide wired and/or wireless network connections. In some cases, network adapter 430 may include an Ethernet adapter or Fibre Channel adapter. Storage adapter 435 may enable apparatus 405 to access one or more data storage devices such as storage device 110. The one or more data storage devices may include two or more data tiers each. The storage adapter 435 may include one or more of an Ethernet adapter, a Fibre Channel adapter, Fibre Channel Protocol (FCP) adapter, a SCSI adapter, and iSCSI protocol adapter.

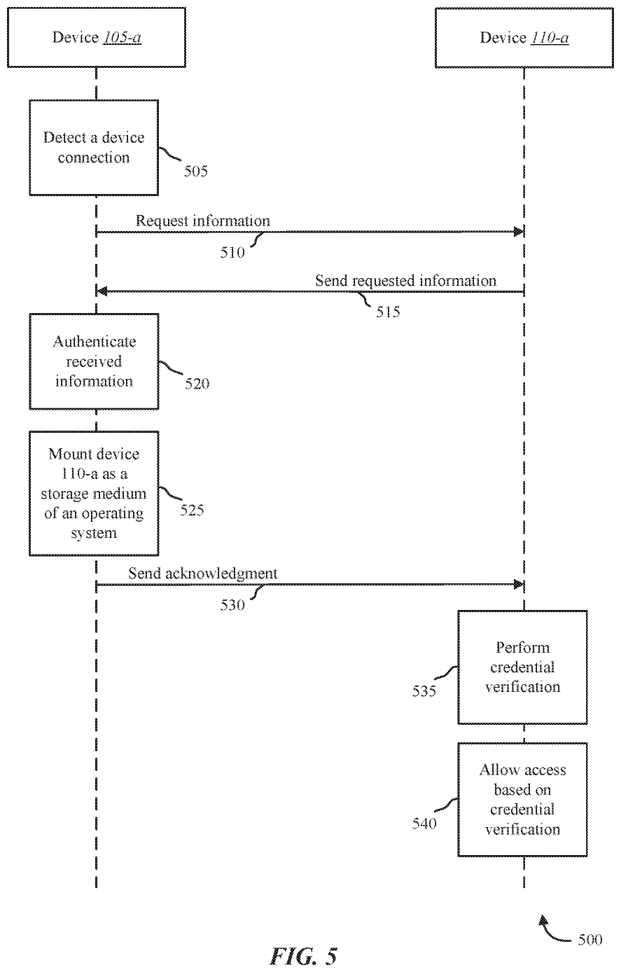

FIG. 5 shows an environment 500 for 2-way dual authentication, in accordance with various examples. As depicted, environment 500 may include device 105-a and device 110-a. At least one aspect of environment 500 may be implemented by or in conjunction with device 105 and/or device 110 of FIG. 1, apparatus 205 of FIG. 2, apparatus 405 of FIG. 4, and/or authentication module 130 depicted in FIGS. 1, 2, 3, and/or 4.

At 505, device 105-a may detect a device connection. For example, device 105-a may detect device 110-a connecting to device 105-a (e.g., device 110-a connecting to a universal serial bus (USB) port of device 105-a, etc.).

At 510, device 105-a may request device identification based at least in part on the detection of the device connection at 505. For example, device 105-a may request device 110-a send information regarding one or more identifiers associated with device 110-a.

At 515, device 110-a may send the requested information to device 105-a. In some cases, the requested information sent by device 110-a at 515 may include at least one of a device serial number of device 110-a, a globally unique identifier uniquely associated with device 110-a, a serial number of device 105-a, a globally unique identifier uniquely associated with device 105-a, a host machine name associated with device 105-a, a media access control (MAC) number of device 105-a, a processor identifier of a processor of device 105-a, a motherboard serial number of device 105-a, a unique random generated number generated by device 110-a after receiving the request at 510 (e.g., a one-time password, a time-based one-time password created based on a secret key held by device 110-a and/or device 105-a), or any combination thereof. In one example, device 110-a may send at least a portion of information stored in a memory (read-only memory, flash memory, etc.) on device 110-a. In some cases, the memory may be located on a bridge of device 110-a. In some cases, the memory may store a provisioning file that includes at least a portion of the requested information. In one example, device 110-a may include a storage device with a storage controller and storage medium. In some examples, the bridge may be located between an external interface of device 110-a (e.g., USB port, etc.) and the storage controller and/or storage medium of device 110-a. In some cases, the storage controller and/or storage medium may remain unavailable to any device outside device 110-a until device 110-a is authenticated by an external device (e.g., device 105-a) and/or until device 110-a verifies credentials. Thus, to enable device 110-a to provide the information requested at 510 (e.g., while the storage controller and/or storage medium remain unavailable), the memory on the bridge may store the requested information and make it available to device 105-a upon request. In some cases, the bridge of device 110-a may include a controller configured to identify when device 110-a connects to an external device, to identify when a message is received from an external device (e.g., the request at 510), etc.), to retrieve information from a memory on the bridge, and/or to send the retrieved information to an external device (e.g., sending the requested information at 515, etc.).

At 520, device 105-a may authenticate the information received from device 110-a. For example, device 105-a may determine whether information received from device 110-a matches data previously stored on device 105-a. In one example, the information sent by device 110-a may include an identifier of device 110-a and/or an identifier of device 105-a. Accordingly, at 520 device 105-a may determine whether the information received from device 110-a includes an identifier of device 110-a and/or an identifier of device 105-a. Upon determining the information includes the identifier of device 110-a and/or an identifier of device 105-a, device 105-a may determine whether the provided identifier of device 110-a and/or an identifier of device 105-a match a stored identifier of device 110-a and/or a stored identifier of device 105-a previously stored at device 110-a. In some cases, the information received from device 110-a may include a random generated number that is generated based on a secret key held by device 110-a and device 105-a. Accordingly, in some cases, device 105-a may generate a random number using the secret key and determine whether the random number from device 110-a matches the random number generated by device 105-a.

At 525, after authenticating the information received from device 110-a, device 105-a may mount device 110-a as a storage medium on an operating system of device 105-a.

At 530, after mounting device 110-a, device 105-a may send an acknowledgement to device 110-a. In some cases, the acknowledgment may include an indication that device 105-a has mounted 110-a as a storage medium of the operating system. For example, mounting device 110-a as a storage medium of the operating system may include one or more messages sent between device 105-a and device 110-a, and the one or more messages may include the acknowledgment. In some cases, device 110-a may monitor device 105-a and determine that device 105-a mounts device 110-a as a storage medium of its operating system based on the monitoring.

At 535, device 110-a may perform a credential verification after determining device 105-a has mounted device 110-a as a storage medium of its operating system (e.g., after receiving acknowledgment at 530, etc.). In some cases, credential verification may include device 110-a requesting user credentials (e.g., a user name and/or password, etc.), receiving the requested credentials, and verifying the credentials.

At 540, device 110-a may allow access to at least a portion of its storage medium after successfully verifying the credentials at 535. In some cases, device 110-a may enable decryption of encrypted data stored on its storage medium after successfully verifying the credentials at 535. In some cases, device 110-a may include a plurality of storage mediums (e.g., hard disks, flash memory chips, etc.), and may allow access to at least a portion of at least one of its storage mediums after successfully verifying the credentials at 535.

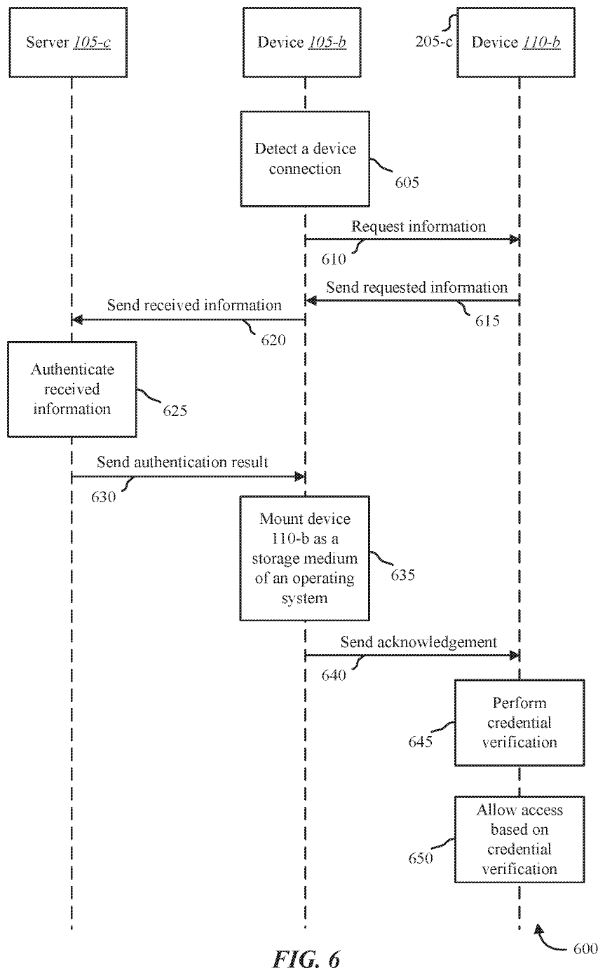

FIG. 6 shows an environment 600 for 2-way dual authentication, in accordance with various examples. As depicted, environment 600 may include device 105-b, device 110-b, and server 105-c. At least one aspect of environment 600 may be implemented by or in conjunction with device 105 and/or device 110 of FIG. 1 and/or 5, apparatus 205 of FIG. 2, apparatus 405 of FIG. 4, and/or authentication module 130 depicted in FIGS. 1, 2, 3, and/or 4.

At 605, device 105-b may detect a device connection. For example, device 105-b may detect device 110-b connecting to device 105-b (e.g., device 110-b connecting to a USB port of device 105-b, etc.).

At 610, device 105-b may request device identification based at least in part on the detection of the device connection at 605. For example, device 105-b may request device 110-b send information regarding one or more identifiers associated with device 110-b.

At 615, device 110-b may send the requested information to device 105-b. In some cases, the requested information sent by device 110-b at 615 may include at least one of a device serial number of device 110-b, a globally unique identifier uniquely associated with device 110-b, a serial number of device 105-b, a globally unique identifier uniquely associated with device 105-b, a host machine name associated with device 105-b, a media access control (MAC) number of device 105-b, a processor identifier of a processor of device 105-b, a motherboard serial number of device 105-b, a unique random generated number generated by device 110-b after receiving the request at 610 (e.g., a one-time password, a time-based one-time password created based on a secret key held by device 110-b, device 105-b, and/or server 105-c), or any combination thereof. In one example, device 110-b may send at least a portion of information stored in a memory on device 110-b. In some cases, the memory may be located on a bridge or connection interface of device 110-b. In some cases, the memory may store a provisioning file that includes at least a portion of the requested information.

At 620, device 105-b may send the information received from device 110-b at 615 to server 105-c. In some cases, device 105-b may verify the received information (e.g., requested identification) and then send the verified information to server 105-c after successfully verifying the information received from device 110-b. Alternatively, device 105-b may send the received information to server 105-c without first verifying the received information. In some cases, server 105-c may be located remotely from device 105-b and/or device 110-b. For example, server 105-c may be a remotely located authentication server.

At 625, server 105-c may authenticate the information received from device 105-b at 620. For example, server 105-c may determine whether information received from device 105-b matches data previously stored on server 105-c. In one example, the information sent by device 105-b may include an identifier of device 110-b and/or an identifier of device 105-b. Accordingly, at 625 server 105-c may determine whether the information received from device 105-b includes an identifier of device 110-b and/or an identifier of device 105-b. Upon determining the information includes the identifier of device 110-b and/or identifier of device 105-b, server 105-c may determine whether the provided identifier of device 110-b and/or an identifier of device 105-b match a stored identifier of device 110-b and/or a stored identifier of device 105-b previously stored at server 110-c. In some cases, the information received from device 110-b may include a random generated number that is generated based on a secret key held by device 110-b. In some cases, server 105-c and/or device 105-a may include the same secret key. Accordingly, in some cases, server 105-c may generate a random number using the secret key and indicate the received information is authenticated based at least in part on the random number from device 110-b matching the random number generated by server 105-c. In some cases, device 110-b may generate a first random number using the secret key and send the first random number to device 105-b and device 105-b may generate a second random number using the secret key after receiving the information at 615 (e.g., including the random number generated by device 110-b). In some examples, at 620 device 105-b may send the first random number and the second random number to server 105-c. Accordingly, server 105-c may generate a third random number using the secret key and indicate the received information is authenticated based at least in part on the third random number matching both the first random number and the second random number.

At 630, server 105-c may send a result of the authentication to device 105-b. For example, server 105-c may send a message or an indication to device 105-b indicating whether or not authentication passed (e.g., a binary “1” to indicate authentication is successful, or a binary “0” to indicate authentication failed, etc.).

At 635, after receiving an indication that the information was successfully authenticated, device 105-b may mount device 110-b as a storage medium on an operating system of device 105-b. When the authentication result of 630 indicates authentication failed, device 105-b may send a fail message or fail indication to device 110-b (e.g., a binary “1” to indicate authentication is successful, or a binary “0” to indicate authentication failed, etc.). Alternatively, when the authentication result of 630 indicates authentication failed, device 105-b may ignore further communication from device 110-b. In some cases, when the authentication result of 630 indicates authentication failed, device 105-b may post a failure notification on a screen associated with device 105-b.

At 640, after mounting device 110-b device 105-b may send an acknowledgement to device 110-b. In some cases, the acknowledgment may include an indication that device 105-b has mounted 110-b as a storage medium of the operating system. In some cases, device 110-b may monitor device 105-b and determine that device 105-b mounts device 110-b as a storage medium of its operating system based on the monitoring.

At 645, device 110-b may perform a credential verification after determining device 105-b has mounted device 110-b as a storage medium of its operating system. In some cases, credential verification may include device 110-b requesting user credentials (e.g., a user name and/or password, etc.), receiving the requested credentials, and verifying the credentials.

At 650, device 110-b may allow access to at least a portion of its storage medium after successfully verifying the credentials at 645. In some cases, device 110-b may enable decryption of encrypted data stored on its storage medium after successfully verifying the credentials at 650.

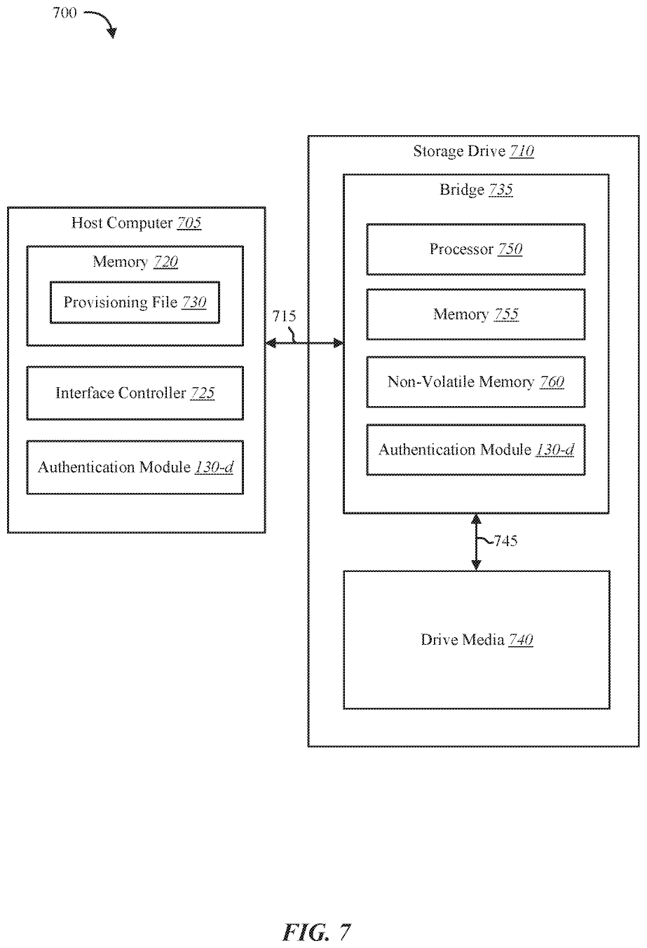

FIG. 7 shows a system 700 for 2-way dual authentication, in accordance with various examples. In the illustrated example, system 700 may include host computer 705, which may be an example of any one of device 105 of FIG. 1 and/or apparatus 405 of FIG. 4. As shown, system 700 may include storage drive 710, which may be an example of any one of device 105 of FIG. 1, apparatus 205 of FIG. 2, and/or apparatus 405 of FIG. 4.

As shown, host computer 705 may connect to storage drive 710 via drive interface 715. In some cases, drive interface 715 may include any combination of wired and/or wireless connections. Examples of drive interface 715 include universal serial bus (USB), Institute of Electrical and Electronics Engineers (IEEE) 1394, WiFi, etc.

In the illustrated example, host computer 705 may include memory 720, interface controller 725, and authentication module 130-d. As shown, memory 720 may include provisioning file 730, which may be an example of provisioning file 260 of FIG. 2.

In the illustrated example, storage drive 710 may include bridge 735, drive media 740, and media interface 745. In some cases, drive media 740 may be an example of drive media 225 of FIG. 2. In some cases, bridge 735 may be a communication bridge between communication over drive interface 715 and communications over media interface 745. In some cases, media interface 745 may include a serial advanced technology attachment (SATA) interface to drive media 740. In some cases, drive media 740 may include hard disk storage media, flash memory storage media, or a combination thereof. In one example, bridge 735 may include a USB to SATA bridge when drive interface 715 includes a USB interface and media interface includes a SATA interface. As shown, bridge 735 may include processor 750 (e.g., processor 230 of FIG. 2, processor 445 of FIG. 4), memory 755 (e.g., memory 250 of FIG. 2, memory 410 of FIG. 4), non-volatile memory 760 (e.g., memory 250 of FIG. 2, memory 410 of FIG. 4), and authentication module 130-d.

In one example, storage drive 710 may be connected to host computer 705 via drive interface 715. In some cases, host computer 705 may detect storage drive 710 connecting to a port of host computer 705 via drive interface 715 (e.g., a USB port of storage drive 710 connecting to a USB port of host computer 705 via a USB cable).

In one example, host computer 705 may request device identification based at least in part on the detection of storage drive 710 connecting via drive interface 715. For example, host computer 705 may request storage drive 710 send information regarding one or more identifiers associated with storage drive 710.

In one example, storage drive 710 may send the requested information to host computer 705. In some cases, the requested information sent by storage drive 710 to host computer 705 may include at least one of a device serial number of storage drive 710, a globally unique identifier uniquely associated with storage drive 710, a serial number of host computer 705, a globally unique identifier uniquely associated with host computer 705, a host machine name associated with host computer 705, a media access control (MAC) number of host computer 705, a processor identifier of processor 750, a processor identifier of a processor of host computer 705, a motherboard serial number of host computer 705, a unique random generated number generated by storage drive 710 after receiving the request for device identification (e.g., a one-time password, a time-based one-time password created based on a secret key held by storage drive 710 and/or host computer 705), or any combination thereof. In one example, storage drive 710 may send at least a portion of information stored in a memory on storage drive 710 (e.g., memory 755 and/or non-volatile memory 760).

In some examples, a storage controller and/or drive media 740 of storage drive 710 may remain unavailable to any device outside storage drive 710 until storage drive 710 is authenticated by an external device (e.g., host computer 705) and/or until storage drive 710 verifies credentials. Thus, to enable storage drive 710 to provide the information requested by host computer 705 (e.g., while the storage controller and/or drive media 740 remain unavailable), the memory on the bridge 735 (e.g., memory 755 and/or non-volatile memory 760) may store the requested information and make it available to host computer 705 upon request. In some cases, bridge 735 of storage drive 710 may include a microcontroller (e.g., processor 750) configured to identify when storage drive 710 connects to an external device (e.g., host computer 705), to identify when a message is received from an external device (e.g., the request for device identification from host computer 705, etc.), to retrieve information from a memory on the bridge 735 (e.g., memory 755 and/or non-volatile memory 760), and/or to send the retrieved information to an external device (e.g., sending the requested information to host computer 705, etc.).

In one example, host computer 705 may authenticate the information received from storage drive 710. For example, host computer 705 may determine whether information received from storage drive 710 matches data previously stored on host computer 705 (e.g., provisioning file 730). In one example, the information sent by storage drive 710 may include an identifier of storage drive 710 and/or an identifier of host computer 705. Accordingly, host computer 705 may determine whether the information received from storage drive 710 includes an identifier of storage drive 710 and/or an identifier of host computer 705. Upon determining the information includes the identifier of storage drive 710 and/or an identifier of host computer 705, host computer 705 may determine whether the provided identifier of storage drive 710 and/or an identifier of host computer 705 match a stored identifier of storage drive 710 and/or a stored identifier of host computer 705 previously stored at storage drive 710 (e.g., stored in provisioning file 730). In some cases, the information received from storage drive 710 may include a random generated number that is generated based on a secret key held by storage drive 710 and host computer 705. Accordingly, in some cases, host computer 705 may generate a random number using the secret key and determine whether the random number from storage drive 710 matches the random number generated by host computer 705.

In one example, after authenticating the information received from storage drive 710, host computer 705 may mount storage drive 710 as a storage medium on an operating system of host computer 705.

In one example, after mounting storage drive 710, host computer 705 may send an acknowledgement to storage drive 710. In some cases, the acknowledgment may include an indication that host computer 705 has mounted storage drive 710 as a storage medium of the operating system. For example, mounting storage drive 710 as a storage medium of the operating system may include one or more messages sent between host computer 705 and storage drive 710, and the one or more messages may include the acknowledgment. In some cases, storage drive 710 may monitor host computer 705 (e.g., via processor 750 of bridge 735) and determine that host computer 705 mounts storage drive 710 as a storage medium of its operating system based on the monitoring.

In one example, storage drive 710 may perform a credential verification after determining host computer 705 has mounted storage drive 710 as a storage medium of its operating system (e.g., after receiving acknowledgment from host computer 705, etc.). In some cases, credential verification may include storage drive 710 requesting user credentials (e.g., a user name and/or password, etc.), receiving the requested credentials from host computer 705, and verifying the credentials.

In one example, storage drive 710 may allow access to at least a portion of drive media 740 after successfully verifying the credentials. In some cases, storage drive 710 may enable decryption of encrypted data stored on drive media 740 after successfully verifying the credentials. In some cases, storage drive 710 may include a plurality of storage mediums (e.g., drive media 740 including hard disks, flash memory chips, or any combination thereof), and may allow access to at least a portion of at least one of its multiple storage mediums after successfully verifying the credentials.

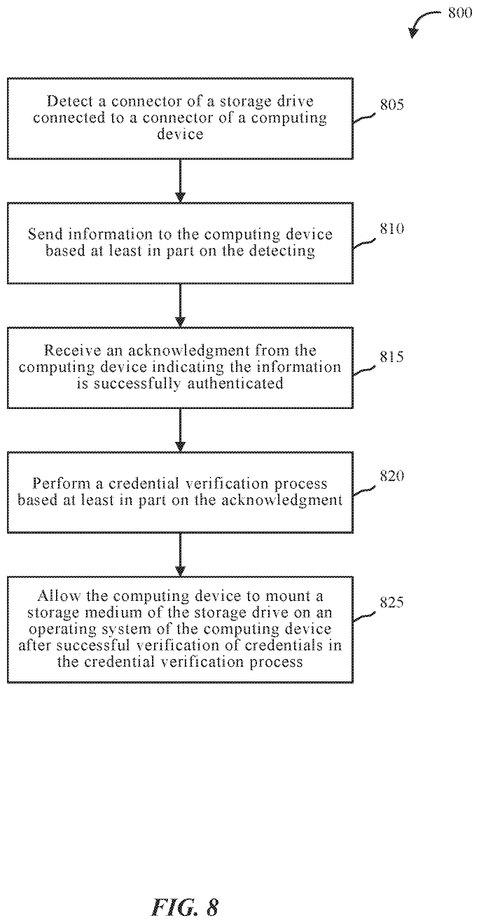

FIG. 8 is a flow chart illustrating an example of a method 800 for 2-way dual authentication, in accordance with various aspects of the present disclosure. One or more aspects of the method 800 may be implemented in conjunction with device 105 of FIG. 1, apparatus 205 of FIG. 2, and/or authentication module 130 depicted in FIGS. 1, 2, 3, and/or 4. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 805, the method 800 may include detecting a connector of the storage drive connected to a connector of a computing device.

At block 810, the method 800 may include sending information to the computing device based at least in part on the detecting.

At block 815, the method 800 may include receiving an acknowledgment from the computing device indicating the computing device successfully authenticated the information.

At block 820, the method 800 may include performing a credential verification process based at least in part on the acknowledgment.

At block 825, the method 800 may include allowing the computing device to mount a storage medium of the storage drive on an operating system of the computing device after successful verification of credentials in the credential verification process.

The operation(s) at block 805-825 may be performed using the authentication module 130 described with reference to FIGS. 1-4 and/or another module. Thus, the method 800 may provide for 2-way dual authentication. It should be noted that the method 800 is just one implementation and that the operations of the method 800 may be rearranged, omitted, and/or otherwise modified such that other implementations are possible and contemplated.

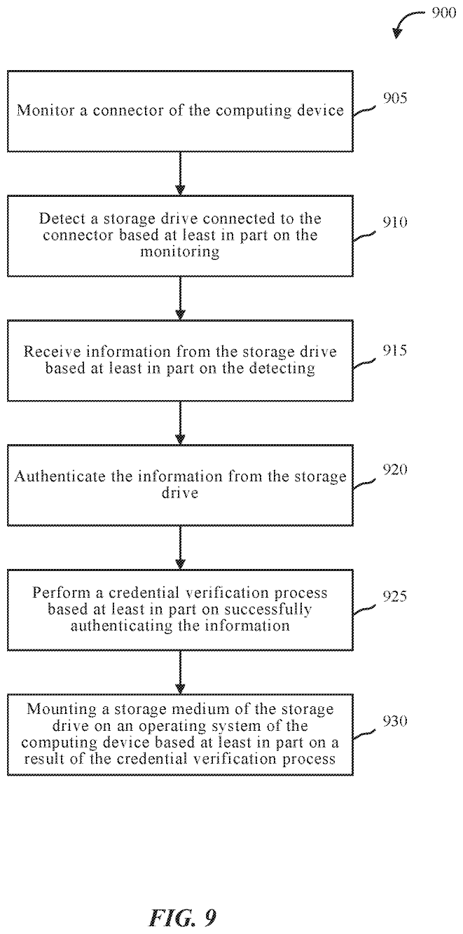

FIG. 9 is a flow chart illustrating an example of a method 900 for 2-way dual authentication, in accordance with various aspects of the present disclosure. One or more aspects of the method 900 may be implemented in conjunction with device 105 of FIG. 1, apparatus 205 of FIG. 2, and/or authentication module 130 depicted in FIGS. 1, 2, 3, and/or 4. In some examples, a backend server, computing device, and/or storage device may execute one or more sets of codes to control the functional elements of the backend server, computing device, and/or storage device to perform one or more of the functions described below. Additionally or alternatively, the backend server, computing device, and/or storage device may perform one or more of the functions described below using special-purpose hardware.

At block 905, the method 900 may include monitoring a connector of the computing device.

At block 910, the method 900 may include detecting a storage drive connected to the connector based at least in part on the monitoring.

At block 915, the method 900 may include receiving information from the storage drive based at least in part on the detecting at block 905

At block 920, the method 900 may include authenticating the information from the storage drive.

At block 925, the method 900 may include performing a credential verification process based at least in part on successfully authenticating the information.

At block 930, the method 900 may include mounting a storage medium of the storage drive on an operating system of the computing device based at least in part on a result of the credential verification process.

The operations at blocks 905-930 may be performed using the authentication module 130 described with reference to FIGS. 1-4 and/or another module. Thus, the method 900 may provide for 2-way dual authentication. It should be noted that the method 900 is just one implementation and that the operations of the method 900 may be rearranged, omitted, and/or otherwise modified such that other implementations are possible and contemplated.

In some examples, aspects from two or more of the methods 800 and 900 may be combined and/or separated. It should be noted that the methods 800 and 900 are just example implementations, and that the operations of the methods 800 and 900 may be rearranged or otherwise modified such that other implementations are possible.

The detailed description set forth above in connection with the appended drawings describes examples and does not represent the only instances that may be implemented or that are within the scope of the claims. The terms “example” and “exemplary,” when used in this description, mean “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with this disclosure may be implemented or performed with a general-purpose processor, a digital signal processor (DSP), an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, and/or state machine. A processor may also be implemented as a combination of computing devices, for example, a combination of a DSP and a microprocessor, multiple microprocessors, one or more microprocessors in conjunction with a DSP core, and/or any combination thereof.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC, or A and B and C.

In addition, any disclosure of components contained within other components or separate from other components should be considered exemplary because multiple other architectures may potentially be implemented to achieve the same functionality, including incorporating all, most, and/or some elements as part of one or more unitary structures and/or separate structures.

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, flash memory, CD-ROM, DVD, or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, or any combination thereof, then the coaxial cable, fiber optic cable, twisted pair, DSL, or wireless technologies such as infrared, radio, and/or microwave are included in the definition of medium. Disk and disc, as used herein, include any combination of compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed.

This disclosure may specifically apply to security system applications. This disclosure may specifically apply to storage system applications. In some embodiments, the concepts, the technical descriptions, the features, the methods, the ideas, and/or the descriptions may specifically apply to storage and/or data security system applications. Distinct advantages of such systems for these specific applications are apparent from this disclosure.

The process parameters, actions, and steps described and/or illustrated in this disclosure are given by way of example only and can be varied as desired. For example, while the steps illustrated and/or described may be shown or discussed in a particular order, these steps do not necessarily need to be performed in the order illustrated or discussed. The various exemplary methods described and/or illustrated here may also omit one or more of the steps described or illustrated here or include additional steps in addition to those disclosed.

Furthermore, while various embodiments have been described and/or illustrated here in the context of fully functional computing systems, one or more of these exemplary embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may permit and/or instruct a computing system to perform one or more of the exemplary embodiments disclosed here.

This description, for purposes of explanation, has been described with reference to specific embodiments. The illustrative discussions above, however, are not intended to be exhaustive or limit the present systems and methods to the precise forms discussed. Many modifications and variations are possible in view of the above teachings. The embodiments were chosen and described in order to explain the principles of the present systems and methods and their practical applications, to enable others skilled in the art to utilize the present systems, apparatus, and methods and various embodiments with various modifications as may be suited to the particular use contemplated.

What is claimed is:

1. A storage drive comprising:
a hardware controller configured to:
detect a connector of the storage drive connected to a connector of a computing device;
send information to the computing device based at least in part on the detecting;
receive an acknowledgment from the computing device indicating the information is successfully authenticated;
perform a credential verification process based at least in part on the acknowledgment; and
allow the computing device to mount a storage medium of the storage drive on an operating system of the computing device after successful verification of credentials in the credential verification process.

2. The storage drive of claim 1, wherein the hardware controller is further configured to:
prevent the credential verification process based at least in part on failing to receive the acknowledgment within a set time period or after receiving a negative acknowledgment from the computing device, wherein the computing device is prevented from mounting the storage medium without the successful verification of the credentials in the credential verification process.

3. The storage drive of claim 1, wherein performing the credential verification process includes the hardware controller being further configured to:
request the credentials from the computing device, wherein the credentials include at least one of a user name and password, a fingerprint scan, an eye scan, a face scan, a voice capture, or any combination thereof.

4. The storage drive of claim 3, wherein performing the credential verification process further includes the hardware controller being configured to:
receive the requested credentials from the computing device; and
verify the received credentials.

5. The storage drive of claim 1, wherein sending the information to the computing device includes the hardware controller being configured to:
send to the computing device a provisioning file stored on the storage drive or data that is saved to the provisioning file.

6. The storage drive of claim 5, wherein the provisioning file is stored on a memory located on a bridge interface of the storage drive.

7. The storage drive of claim 6, wherein the bridge interface is connected between the hardware controller of the storage drive and the connector of the storage drive.

8. The storage drive of claim 5, wherein the data stored in the provisioning file includes at least one of a device serial number of the storage drive, a globally unique identifier uniquely associated with the storage drive, a serial number of the computing device, a globally unique identifier uniquely associated with the computing device, a host machine name associated with computing device, a media access control (MAC) number of the computing device, a processor identifier of a processor of computing device, a motherboard serial number of the computing device, or a unique random generated number generated by the storage drive based at least in part on the detecting, or any combination thereof.

9. The storage drive of claim 8, wherein the connector of the storage drive includes a universal serial bus (USB) connector.

10. The storage drive of claim 1, wherein the storage drive includes a self-encrypting drive.

11. A computing device comprising:
one or more processors;
memory in electronic communication with the one or more processors, wherein the memory stores computer executable instructions that when executed by the one or more processors cause the one or more processors to perform the steps of:
monitoring a connector of the computing device;
detecting a storage drive connected to the connector based at least in part on the monitoring;
receiving information from the storage drive based at least in part on the detecting;
authenticating the information from the storage drive;
performing a credential verification process based at least in part on successfully authenticating the information; and
mounting a storage medium of the storage drive on an operating system of the computing device based at least in part on a result of the credential verification process.

12. The computing device of claim 11, wherein the instructions for performing the credential verification process further cause the one or more processors to perform the steps of:
receiving credentials from a user;
sending the credentials to the storage drive for verification; and
receiving the result of the credential verification process from the storage drive, the result indicating that the credentials are valid or that the credentials are invalid, wherein the one or more processors mounting the storage medium when the result indicates the credentials are valid.

13. The computing device of claim 11, wherein receiving the information from the storage drive includes receiving a file stored on the storage drive or receiving data from the file.

14. The computing device of claim 13, wherein the file includes at least one of a drive identifier unique to the storage drive, a computer identifier unique to the computing device, or a random generated number, or any combination thereof.

15. The computing device of claim 11, wherein the instructions for authenticating the information when executed by the one or more processors cause the one or more processors to perform the steps of:
comparing the drive identifier to a local drive identifier stored on at least one of an internal storage drive of the computing device and a remote storage drive; and
indicating the information is authenticated when the comparing indicates a match between the drive identifier and the local drive identifier.

16. The computing device of claim 14, wherein the instructions for authenticating the information when executed by the one or more processors cause the one or more processors to perform the steps of:
comparing the computer identifier to a device identifier associated with the computing device; and
indicating the information is authenticated when the comparing indicates a match between the computer identifier and the device identifier.

17. The computing device of claim 11, wherein the instructions when executed by the one or more processors cause the one or more processors to perform the steps of:
receiving a command instructing the computing device to block further communication with the storage drive.

18. The computing device of claim 17, wherein the instructions when executed by the one or more processors cause the one or more processors to perform the steps of:
determining whether the storage drive is currently connected to the computing device; and
unmounting the storage drive after determining the storage drive is currently connected.

19. The computing device of claim 18, wherein the instructions when executed by the one or more processors cause the one or more processors to perform the steps of:
removing authentication of the information to block future connections between the computing device and the storage drive after determining the storage drive is not currently connected.

20. A method to improve a storage system comprising:
detecting, by a controller of a storage drive, a connector of the storage drive connected to a connector of a computing device;
sending, by the controller, information to the computing device based at least in part on the detecting;
receiving, by the controller, an acknowledgment from the computing device indicating the information is successfully authenticated;
performing, by the controller, a credential verification process based at least in part on receiving the acknowledgment; and
allowing, by the controller, the computing device to mount a storage medium of the storage drive on an operating system of the computing device after successful verification of credentials in the credential verification process.
